(19) United States
(12) Patent Application Publication
(10) Pub. No.: US 2021/0103699 A1
(43) Pub. Date: Apr. 8, 2021

(54) DATA EXTRACTION METHOD AND DATA EXTRACTION DEVICE

(71) Applicant: HITACHI, LTD., Tokyo (JP)

(72) Inventors: Tadashi TAKEUCHI, Tokyo (JP); Eri TERUYA, Tokyo (JP)

(21) Appl. No.: 17/064,683

(22) Filed: Oct. 7, 2020

(30) Foreign Application Priority Data
Oct. 7, 2019 (JP) 2019-184595

(51) Int. Cl. G06F 40/268; G06N 5/02; G06F 17/16; G06K 9/62

(52) U.S. Cl. CPC G06F 40/268; G06K 9/6222; G06F 17/16; G06N 5/025

(57) ABSTRACT

A data extraction device includes: a label input part that receives, from a user, an input of the type of each component of at least one set of sentences and a designation of a topic portion in the component; a model creation part that creates a pre-trained model that has learned the type of each component and a feature of the topic portion in the component; a sentence-feature presuming part that inputs a specified set of sentences inputted by a user into the pre-trained model and a topic portion in each component; a word-vector calculation part that determines a relationship among each word in the specified set of sentences, the type of each presumed component, and the presumed topic portion to calculate a feature amount of each word. A relationship of each of the words based on the calculated feature amount is then extracted.

### CROSS-REFERENCE TO RELATED APPLICATION

This application claims priority pursuant to 35 U.S.C. § 119 from Japanese Patent Application No. 2019-184595, filed on Oct. 7, 2019, the entire disclosure of which is incorporated herein by reference.

### BACKGROUND

### Technical Field

The present disclosure relates to a data extraction method and a data extraction device.

### Related Art

There are cases where a future shortage of skilled workers has been a problem in the fields involving highly specialized work. To address this situation, attempts have been made to build databases containing knowledge and views of skilled workers and to use them effectively. For example, text data in which knowledge and views of skilled workers are recorded is generated, and this text data is referred to by unskilled workers. In addition, it is also being studied that such text data is used for machine learning to create a pre-trained model on the work.

However, since the amount of such text data is usually extremely large, it is desirable also in the viewpoint of improving work efficiency to generate text data only including extracted necessary information.

Here, as data extraction methods, there have been proposed methods of extracting unique expressions from existing text data and creating databases in which the relationship (binary relationship) between the extracted unique expressions has been determined. For example, in a technique disclosed in Japanese Patent Application Publication No. 2007-4458 (hereinafter referred to as patent document 1), a binary-relationship extraction device extracts characteristics of a case from teacher data of binary relationships that occur in text data and makes combinations of sets of characteristics and solutions. Then, the device performs machine learning on what kind of character set leads to what kind of solution in those combinations. The devise also extracts, from text data, binary-relationship candidates and sets of characteristics of the binary-relationship candidates and presumes a solution for a case of a set of characteristics of binary-relationship candidates and the degree of the likeliness based on the learning result information. Then, the device extracts a binary-relationship candidate having a better degree of presumption of a correct solution.

Also, in a technique disclosed in Japanese Patent Application Publication No. 2011-227688 (hereinafter referred to as patent document 2), a device for extracting the relationship between two entities in a text corpus generates a first co-occurrence matrix having elements of frequencies at which each entity pair and each vocabulary pattern are associated, and the device sorts the entity pairs and the vocabulary patterns in the first co-occurrence matrix in the descending order of the frequencies to generate a second co-occurrence matrix. The device performs clustering on the entity pairs and the vocabulary patterns in the second co-occurrence matrix to obtain clusters of entity pairs and clusters of vocabulary patterns, and the device generates a third co-occurrence matrix the row of which is one of the obtained cluster of entity pairs and the obtained cluster of vocabulary patterns and the column of which is the other one and whose elements are the frequencies added by clustering.

### SUMMARY

Unfortunately, the method in patent document 1 has a disadvantage that text of teacher data needs to be given appropriate labels in advance and this makes the step of generating text data troublesome.

The method of patent document 2 does not require manual labeling, but in order to perform machine learning with high accuracy, a large amount of teacher data (entity pairs and vocabulary patterns) has to be prepared which is necessary for clustering based on the co-occurrence probability distribution. For this reason, in the case where the amount of accumulated text data is originally small (for example, in fields of highly specialized work), there has been a problem that machine learning cannot be performed with accuracy high enough for practical use.

The present disclosure has been made in light of the above situation, and an objective thereof is to provide a data extraction method and a data extraction device that are capable of extracting characteristic data from text data appropriately and efficiently according to the work field.

An aspect of the disclosure to solve the above objective is a data extraction device comprising: a label input part that receives, from a user, an input of the type of each component of at least one set of sentences and a designation of a topic portion in the component; a model creation part that creates a pre-trained model that has learned the type of each component of the set of sentences and a feature of the topic portion in the component of the set of sentences; a sentence-feature presuming part that inputs a specified set of sentences inputted by a user into the pre-trained model to presume each component of the specified set of sentences and a topic portion in each component of the specified set of sentences; a word-vector generation part that determines a relationship among each word in the specified set of sentences, the type of each presumed component, and the presumed topic portion to calculate a feature amount of each word; and a relationship extraction part that determines a relationship among each of the words based on the calculated feature amount.

Another aspect of the disclosure is a data extraction method comprising: a label input process of receiving, from a user, an input of the type of each component of at least one set of sentences and a designation of a topic portion in the component; a model creation process of creating a pre-trained model that has learned the type of each component of the set of sentences and a feature of the topic portion in the component of the set of sentences; a sentence-feature presuming process of inputting a specified set of sentences inputted by a user into the pre-trained model to presume each component of the specified set of sentences and a topic portion in each component of the specified set of sentences; a word-vector generation process of determining a relationship among each word in the specified set of sentences, the type of each presumed component, and the presumed topic portion to calculate a feature amount of each word; and a relationship extraction process of outputting information indicating a relationship among each of the words based on the calculated feature amount, wherein the label input process, the model creation process, the sentence-feature presuming process, the word-vector generation process, and the relationship extraction process are performed by an information processing device.

The present disclosure makes it possible to extract characteristic data from text data appropriately and efficiently according to the work field.

Issues, configurations, and effects other than those described above will be made clear by the description of the following embodiments.

### BRIEF DESCRIPTION OF THE DRAWINGS

FIG. 1 is a diagram illustrating an example of the configuration of a work analysis system according to a first embodiment.

FIG. 2 is a diagram for explaining an example of functions included in a data extraction device (part 1).

FIG. 3 is a diagram for explaining an example of functions included in the data extraction device (part 2).

FIG. 4 is a diagram illustrating an example of a set of sentences.

FIG. 5 is a diagram illustrating an example of labeled text data.

FIG. 6 is a diagram for explaining an example of the hardware of each information processing device in the work analysis system.

FIG. 7 is a diagram for explaining an overview of the process performed by the work analysis system.

FIG. 8 is a flowchart for explaining an example a discrimination-model creation process.

FIG. 9 is a flowchart for explaining an example of a first paragraph division process.

FIG. 10 is a diagram for explaining an example of paragraph division rules.

FIG. 11 is a diagram illustrating an example of text data with paragraph information.

FIG. 12 is a flowchart illustrating an example of a first sentence-element division process.

FIG. 13 is a diagram for explaining an example of a method of determining the modification relationship among sentence segments.

FIG. 14 is a diagram illustrating an example of syntax-analysis result data.

FIG. 15 is a diagram illustrating an example of sentence-element division-result data.

FIG. 16 is a flowchart for explaining an example of a label input process.

FIG. 17 is a flowchart for explaining an example of a paragraph-type-discrimination-model creation process.

FIG. 18 is a flowchart for explaining an example of a topic-discrimination-model creation process.

FIG. 19 is a diagram illustrating an example of topic-discrimination-model teacher data.

FIG. 20 is a diagram for explaining an example of the modification relationship among sentence elements.

FIG. 21 is a flowchart for explaining an example of a relationship-information generation process.

FIG. 22 is a flowchart for explaining an example of a paragraph-type presuming process.

FIG. 23 is a flowchart for explaining an example of a topic presuming process.

FIG. 24 is a flowchart for explaining an example of a word-vector calculation and presuming process.

FIG. 25 is a diagram illustrating an example of co-occurrence-word presuming model teacher-data.

FIG. 26 is a diagram for explaining an example of the configuration of a co-occurrence-word presuming model.

FIG. 27 is a flowchart for explaining an example of a relationship extraction process.

FIG. 28 is a diagram illustrating an example of a unique-expression relationship DB.

FIG. 29 is a flowchart for explaining an example of a first sentence-element division process according to a second embodiment.

FIG. 30 is a diagram for explaining an example of syntax-analysis result data.

FIG. 31 is a diagram illustrating an example of sentence-element division-result data in the second embodiment.

FIG. 32 is a flowchart for explaining an example of a topic-discrimination-model creation process according to the second embodiment.

FIG. 33 is a diagram for explaining an example of the modification relationship among sentence elements in the second embodiment.

FIG. 34 is a diagram illustrating an example of topic-discrimination-model teacher data according to the second embodiment.

### DETAILED DESCRIPTION OF EMBODIMENTS

### First Embodiment

### [System Configuration]

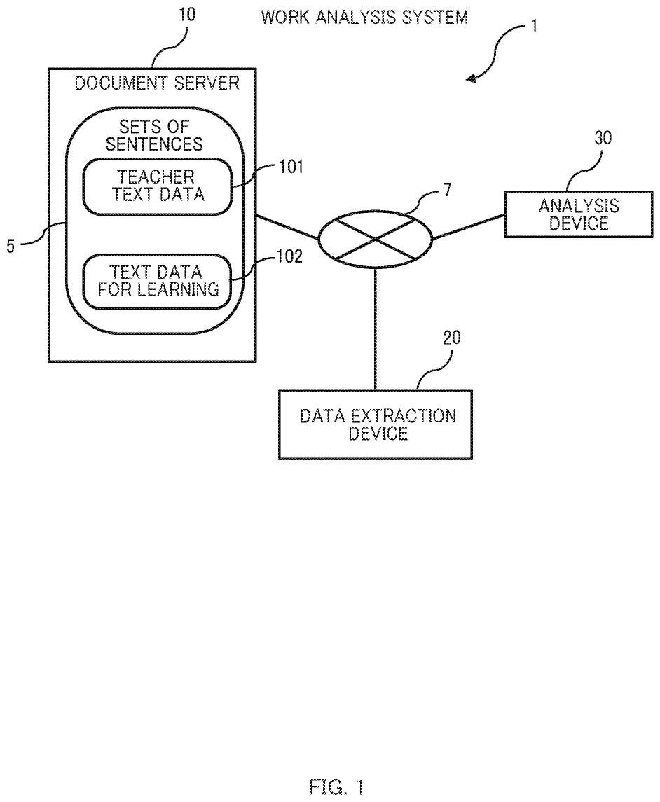

FIG. 1 is a diagram illustrating an example of the configuration of a work analysis system 1 according to a first embodiment. The work analysis system 1 is applied to a work system including a document server 10 in which one or a plurality of sets of sentences 5 created by people who perform specified work are recorded. The work fields in the present embodiment are not limited to any specific ones but are, for example, fields such as railway business, technical research work, and development work.

Specifically, the work analysis system 1 includes the document server 10 that stores the sets of sentences 5, a data extraction device 20 that creates specified databases by using the sets of sentences 5, and an analysis device 30 that performs work analysis based on these databases.

The data extraction device 20 creates specified pre-trained models from the sentences in the sets of sentences 5 to generate information indicating the relationship among a plurality of unique expressions (various words or the like used in the work) in the sets of sentences 5 (hereinafter referred to as relationship information). In the present embodiment, the data extraction device 20 creates a database indicating relationship information.

The sets of sentences 5 include teacher text data 101 for creating pre-trained models and text data for learning 102 for making an input to the pre-trained models. The teacher text data 101 is, for example, data accumulated by then. The text data for learning 102 is, for example, data inputted by specified users every time a new task occurs.

Each set of sentences 5 are sentences in which information on work is recorded. The sets of sentences 5 are, for example, work logs, reports, papers, experiment reports, and the like.

The analysis device 30 performs specified work analysis using the databases created by the data extraction device 20. The analysis device 30 is, for example, a search device that searches for coping methods against problems that occurred on work or a simulator device that performs virtual experiments.

The document server 10, the data extraction device 20, and the analysis device 30 are communicably coupled, for example, by a wired or wireless communication network 7 such as the Internet, a local area network (LAN), and a wide area network (WAN).

Next, the following describes functions included in the data extraction device 20.

### [Functions of Data Extraction Device]

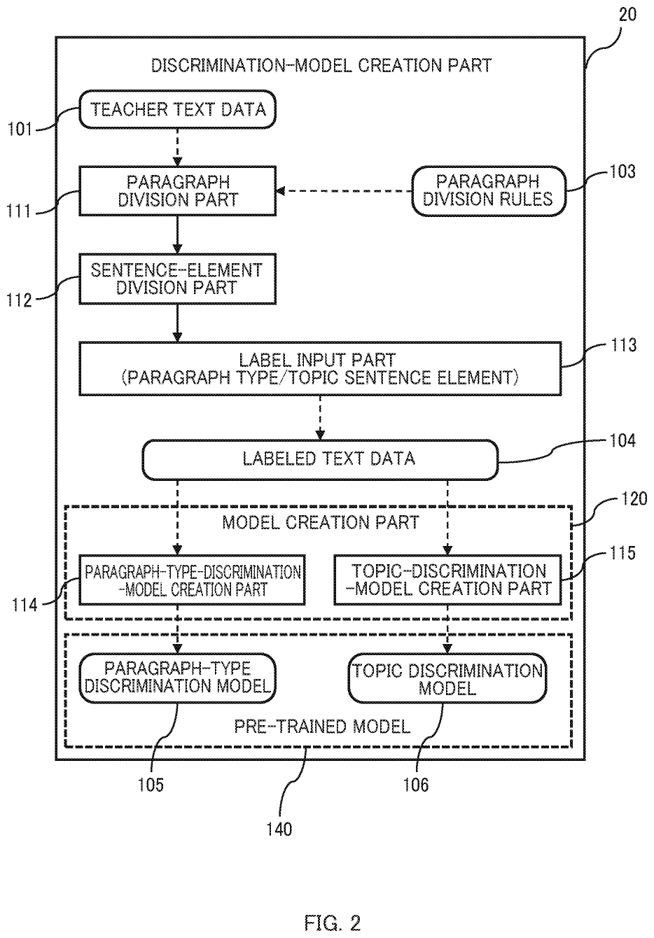

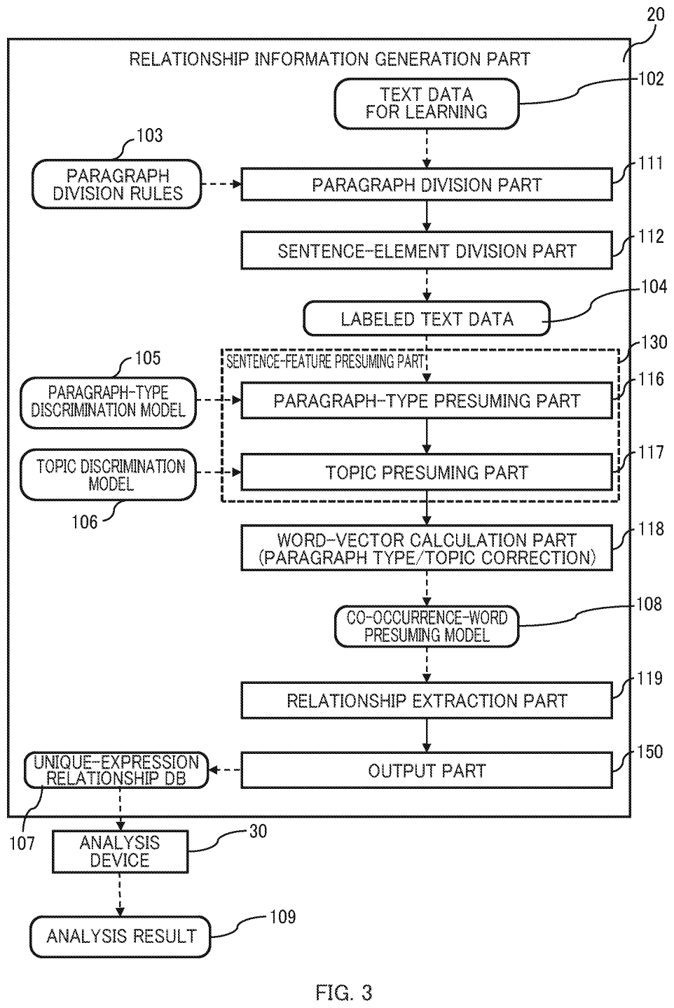

FIGS. 2 and 3 are diagrams for explaining an example of functions of the data extraction device 20 (the functions are shown on the two figures for convenience of illustration). The data extraction device 20 has the functions of a paragraph division part 111, sentence-element division part 112, label input part 113, model creation part 120, sentence-feature presuming part 130, word-vector calculation part 118, relationship extraction part 119, and output part 150.

The paragraph division part 111 divides each set of sentences 5 (the teacher text data 101 and the text data for learning 102) into a plurality of components based on paragraph division rules 103 described later. In the present embodiment, it is assumed that a document in a set of sentences 5 is divided into a plurality of paragraphs. Here, the paragraph may include a description portion of a subitem (title) attached to the paragraph.

Here, the following describes an example of a set of sentences 5.

### (Set of Sentences)

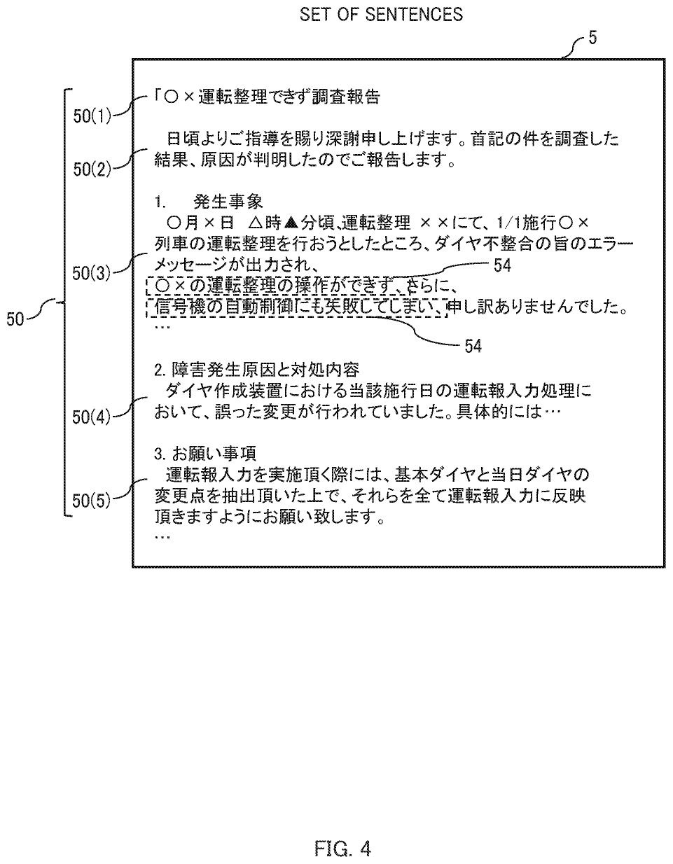

FIG. 4 is a diagram illustrating an example of a set of sentences 5. The set of sentences 5 has the following features.

First, the set of sentences 5 have types or structures of paragraphs unique to the work field. In the example of FIG. 4, the set of sentences 5 can be divided into the paragraphs 50 of a plurality of types including a title 50(1), an introduction 50(2), an event that occurred 50(3), a cause and action 50(4), and a request 50(5).

In addition, in the set of sentences 5, some paragraphs have a topic portion (for example, a sentence segment indicating the gist of the paragraph, which is hereinafter also referred to as a topic sentence-segment), and the topic portions are included in paragraphs of a specific type. In the example of FIG. 4, topic portions 54 are included at certain positions in the paragraph of the event that occurred 50(3).

Based on such features unique to the set of sentences 5, the data extraction device 20 can extract relationship information.

Next, the sentence-element division part 112 illustrated in FIGS. 2 and 3 performs morphological analysis, modification analysis, and the like on each paragraph in the set of sentences 5 divided by the paragraph division part 111 to restructure each sentence of each paragraph according to its logical structure into a set of sentence-segment strings or words (hereinafter referred to as sentence elements) which are equivalent to sentences. Details of sentence elements will be described later.

The label input part 113 illustrated in FIG. 2 receives, from the user, an input of the type of each component (paragraph 50) of the set of sentences 5 (the teacher text data 101) and a designation of the topic portion (topic sentence-segment). Specifically, for example, the label input part 113 displays a specified input screen and receives, from the user, an input of the type of each paragraph in the set of sentences 5 and a designation of the portion of the topic sentence-segment in each paragraph.

Note that the label input part 113 generates information combining the information received from the user and the set of sentences 5 as labeled text data 104.

### (Labeled Text Data)

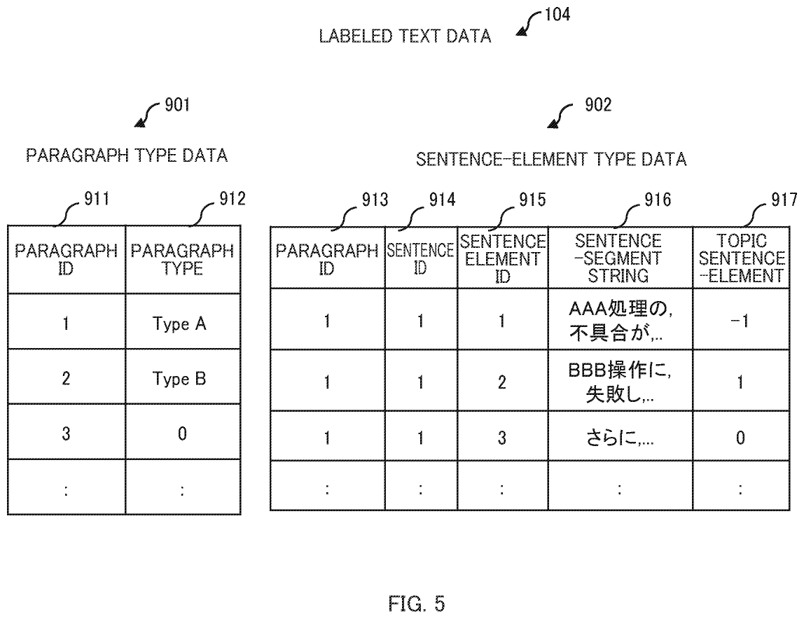

FIG. 5 is a diagram illustrating an example of labeled text data 104. The labeled text data 104 includes paragraph type data 901 and sentence-element type data 902.

The paragraph type data 901 is a database in which the type of each paragraph is recorded and which includes one or more records having the items of “paragraph ID” 911 that stores the identifiers (paragraph IDs) of paragraphs and “paragraph type” 912 that stores the paragraph types according to the paragraph IDs 911 (here, Type A, Type B, . . . ).

The sentence-element type data 902 is a database in which topic sentence-segments are recorded and which includes one or more records having the following items: “paragraph ID” 911 that stores paragraph IDs, “sentence ID” 914 that stores the identifier (sentence ID) of each sentence included in the paragraph according to the paragraph ID 911, “sentence element ID” 915 that stores the identifier (sentence element ID) of each sentence element in the sentence according to the sentence ID 914, “sentence-segment string” 916 that stores the content (character string) of the sentence element according to the sentence element ID 915, and “topic-sentence element” 917 in which information on the topic sentence-segment of the sentence element according to the sentence element ID 915 is set.

Here, in the topic-sentence element 917, if the sentence element has a topic sentence-segment, “1” is set. If the sentence element does not have a topic sentence-segment, “−1” is set. If whether the sentence element has a topic sentence-segment is unknown or whether the sentence element has a topic sentence-segment is going to be presumed with a topic discrimination model 106, “0” is set.

Next, the model creation part 120 illustrated in FIG. 2 creates pre-trained models 140 that have learned the type (paragraph type) of each component of the set of sentences 5 (the teacher text data 101) and the features of the topic portions (topic sentence-segments) in the components (paragraphs) of the set of sentences 5.

Specifically, the model creation part 120 includes a paragraph-type-discrimination-model creation part 114 and a topic-discrimination-model creation part 115.

The paragraph-type-discrimination-model creation part 114 learns the relationship among the words in the set of sentences 5 and the types (paragraph types) of the components based on the labeled text data 104 generated by the label input part 113 and thereby creates, as a first pre-trained model 140, a paragraph-type discrimination model 105 that has memorized the relationship among the words and the types (paragraph type) of the components.

The topic-discrimination-model creation part 115 creates, as a second pre-trained model 140, a topic discrimination model 106 that has memorized the relationship among the types (paragraph types) of the components, the words in each component (paragraph), and the topic portion (topic sentence-segment) in the component (paragraph), based on the labeled text data 104 created by the label input part 113.

Note that the topic-discrimination-model creation part 115 creates, as the topic discrimination model 106, a model that has at least each word in a component (paragraph) and a word having a modification relationship with the word as a feature amount.

Next, as illustrated in FIG. 3, the sentence-feature presuming part 130 inputs a specified set of sentences 5 (the text data for learning 102) inputted by the user into the pre-trained models 140 to presume each component (paragraph) of the specified set of sentences 5 and the topic portion (topic sentence-segment) in each component (paragraph) of the specified set of sentences 5.

Specifically, the sentence-feature presuming part 130 includes a paragraph-type presuming part 116 and a topic presuming part 117.

The paragraph-type presuming part 116 inputs the specified set of sentences 5 (the text data for learning 102) inputted by the user into the first pre-trained model 140 (paragraph-type discrimination model 105) to presume the type (paragraph type) of each component of the specified set of sentences 5.

The topic presuming part 117 inputs the specified set of sentences 5 (text data for learning 102) into the second pre-trained model 140 (topic discrimination model 106) to presume the topic portion (topic sentence-segment) of each component (paragraph) of the specified set of sentences 5.

Note that the topic presuming part 117 inputs each word in a component (paragraph) of the specified set of sentences 5 (text data for learning 102) and a word having a modification relationship with the word into the topic discrimination model 106 to presume the topic portion.

The word-vector calculation part 118 determines the relationship among each word in the specified set of sentences (text data for learning 102), the type of each component presumed by the paragraph-type presuming part 116, and the topic portion presumed by the topic presuming part 117 and thereby calculates the feature amount of each word.

Specifically, the word-vector calculation part 118 learns the relationship among each word in the specified set of sentences 5 (text data for learning 102), the type (paragraph type) of each component presumed by the paragraph-type presuming part 116, and the topic portion (topic sentence-segment) presumed by the topic presuming part 117, thereby creates a co-occurrence-word presuming model 108 that has memorized the relationship among the occurrence of words in the specified set of sentences 5, the types (paragraph types) of the components in the specified set of sentences 5, and the topic portions (topic sentence-segments) of the components (paragraphs), and calculates the feature amount of each word based on the created co-occurrence-word presuming model 108.

The relationship extraction part 119 extracts a plurality of words having a relationship with one another based on the feature amounts calculated by the word-vector calculation part 118.

The output part 150 outputs the plurality of words having a relationship with one another extracted by the relationship extraction part 119. The information on the words is recorded in a unique-expression relationship DB 107 described later. Note that the analysis device 30 is capable of outputting specified analysis results 109 on the work based on this unique-expression relationship DB 107.

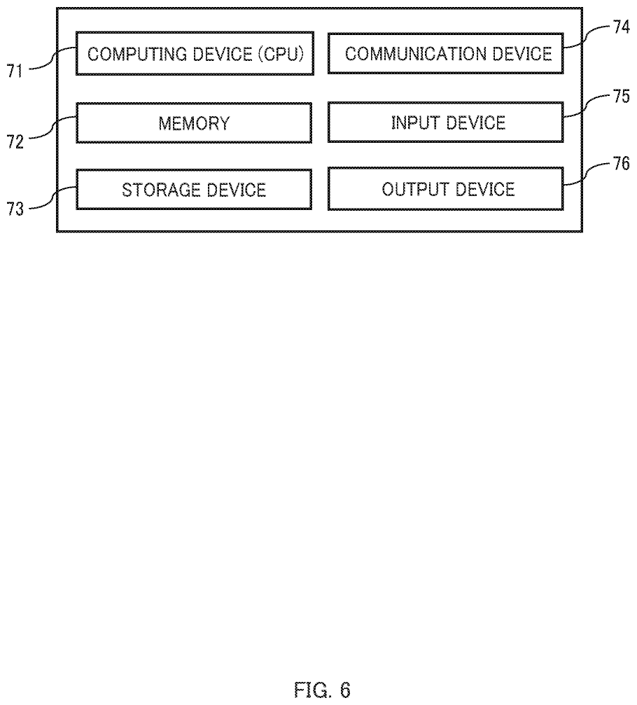

Here, FIG. 6 is a diagram for explaining an example of the hardware of each information processing device in the work analysis system 1. Each information processing device includes a computing device 71 such as a central processing unit (CPU), memory 72 such as random access memory (RAM) and read only memory (ROM), a storage device 73 such as a hard disk drive (HDD) and a solid state drive (SSD), a communication device 74, an input device 75 such as a keyboard, a mouse, and a touch panel, and an output device 76 such as a display and a touch panel. The functional parts in each information processing device described until now are implemented by the hardware of each information processing device or by the computing device 71 of each information processing device reading and executing programs stored in the memory 72 or the storage device 73. These programs are stored, for example, in a secondary storage device, a storage device such as nonvolatile semiconductor memory, a hard disk drive, and an SSD, or a non-transitory data storage medium readable by each information processing device such as an IC card, an SD card, and a DVD.

### [Process]

Next, the following describes the process performed by the work analysis system 1.

### <<Overall Process>>

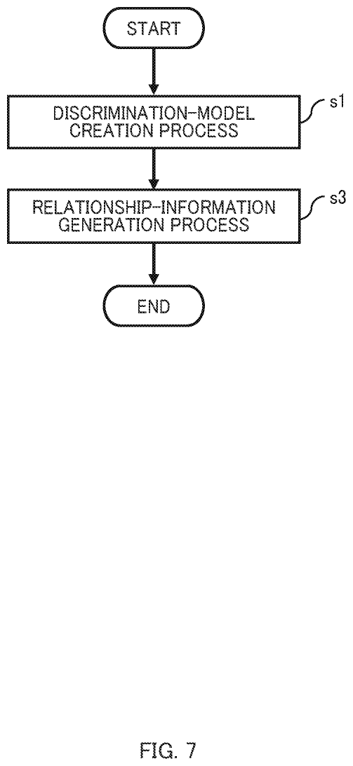

FIG. 7 is a diagram for explaining an overview of the process performed by the work analysis system 1. As illustrated in FIG. 7, the data extraction device 20 first executes a discrimination-model creation process for creating the paragraph-type discrimination model 105 and the topic discrimination model 106 (s1). Then, the data extraction device 20 executes a relationship-information generation process for generating relationship information using these models (s3).

The following describes each of the discrimination-model creation process and the relationship-information generation process.

### <<Discrimination-Model Creation Process>>

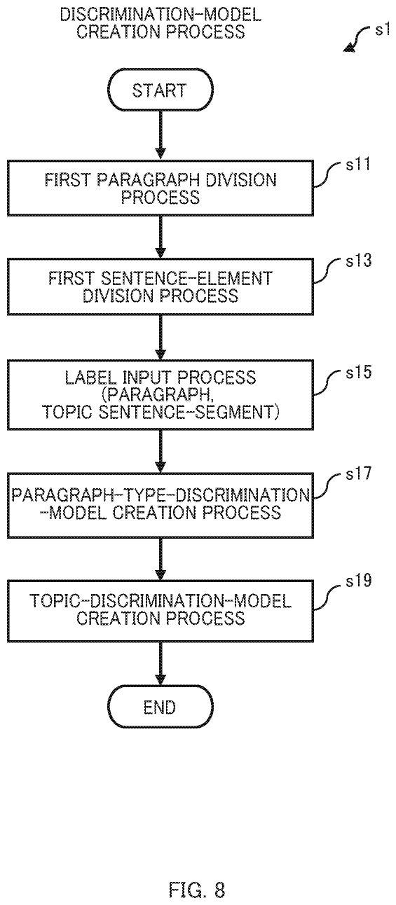

FIG. 8 is a flowchart for explaining an example of the discrimination-model creation process.

First, the paragraph division part 111 of the data extraction device 20 receives teacher text data 101 from the document server 10 and divides each set of sentences 5 in the received teacher text data 101 into paragraphs (a first paragraph division process s11).

Then, the sentence-element division part 112 restructures the paragraphs resulting from the division by the paragraph division part 111 into sentence elements (a first sentence element division process s13).

Meanwhile, the label input part 113 receives an input of the paragraph type of each paragraph in each set of sentences 5 in the teacher text data 101 and an input of the topic sentence-segment of each paragraph in each set of sentences 5 (a label input process s15). Note that the content of each input is recorded in the paragraph type data 901 and sentence-element type data 902 of the labeled text data 104.

Then, the paragraph-type-discrimination-model creation part 114 creates a paragraph-type discrimination model 105 based on the paragraph type data 901 generated at s15 (a paragraph-type-discrimination-model creation process s17). The topic-discrimination-model creation part 115 creates a topic discrimination model 106 based on the sentence-element type data 902 generated at s15 (a topic-discrimination-model creation process s19).

The following describes details of each process in the discrimination-model creation process.

### <First Paragraph Division Process>

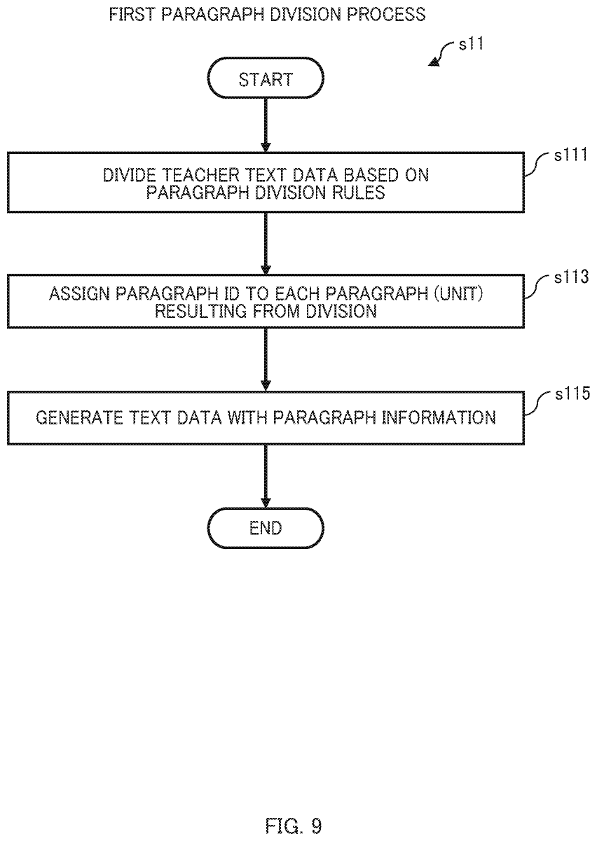

FIG. 9 is a flowchart for explaining an example of the first paragraph division process. First, the paragraph division part 111 divides teacher text data 101 received from the document server 10 into a plurality of paragraphs based on paragraph division rules 103 to be described next (s111). The paragraph division part 111 assigns a paragraph ID to each paragraph resulting from the division (s113) and stores the results of the process at s111 in text data with paragraph information 301 (s115).

Here, the paragraph division rules 103 and the text data with paragraph information 301 are described below.

### Paragraph Division Rules

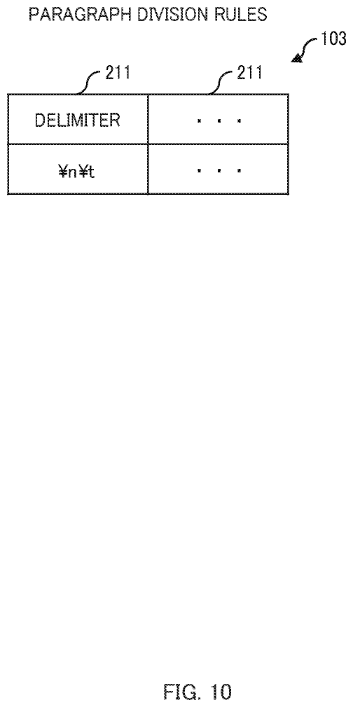

FIG. 10 is a diagram for explaining an example of paragraph division rules 103. The paragraph division rules 103 are information defining the rules used when the set of sentences 5 is divided into paragraphs and has the items including “delimiter” 211 that stores data pieces used as breakpoints (a line-feed data piece in the present embodiment).

Text Data with Paragraph Information

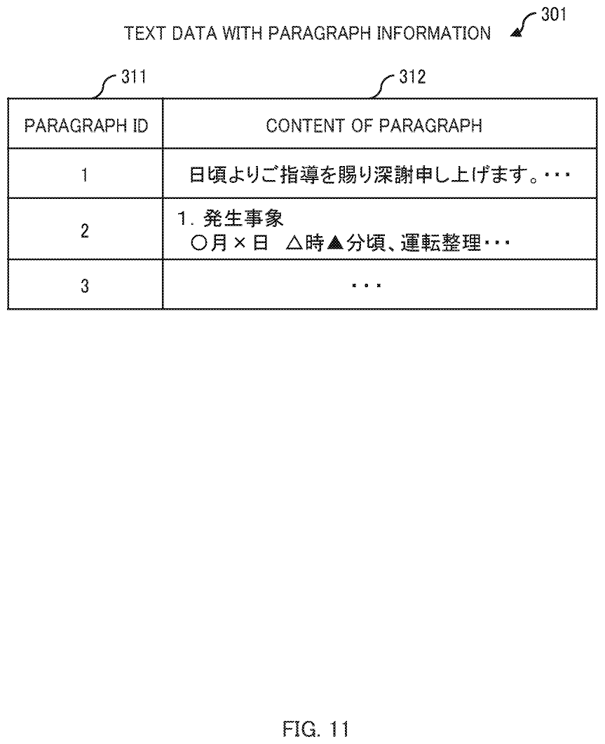

FIG. 11 is a diagram illustrating an example of text data with paragraph information 301. The text data with paragraph information 301 is a database in which the content of each paragraph is registered and which includes one or more records having the items of “paragraph ID” 311 that stores paragraph IDs and “paragraph content” 312 that stores the content of the paragraph according to the paragraph ID 311.

### <First Sentence-Element Division Process>

The following describes a first sentence-element division process.

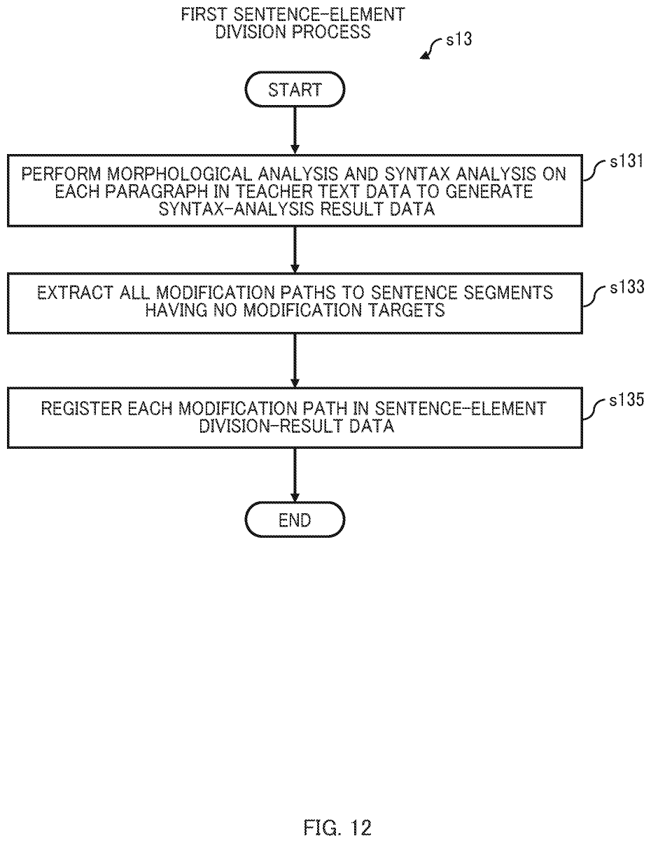

FIG. 12 is a flowchart illustrating an example of the first sentence-element division process. A first sentence-element division part 112 performs specified morphological analysis and syntax analysis on each paragraph in the teacher text data 101 determined in the first paragraph division process to determine each sentence segment in the teacher text data 101 and records the results in syntax-analysis result data 501 described later (s131).

The first sentence-element division part 112 refers to the syntax-analysis result data 501 to determine all the modification relationships (paths) of all the sentence segments in each paragraph of the teacher text data 101 and thereby determines the sentence elements of each sentence (s133). Then, the first sentence-element division part 112 stores information on the determined sentence elements in sentence-element division-result data 601 described later (s135).

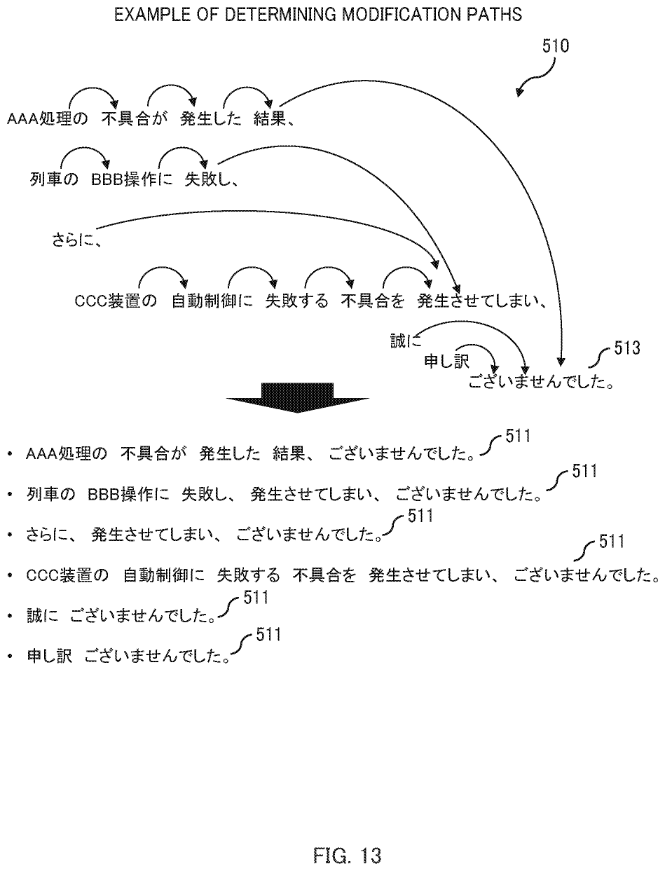

Note that FIG. 13 is a diagram for explaining an example of a method for determining the modification relationships between sentence segments. As illustrated in FIG. 13, this sentence 510 is restructured into a plurality of sentence elements 511 each having the last sentence segment 513 in common.

### (Syntax-Analysis Result Data)

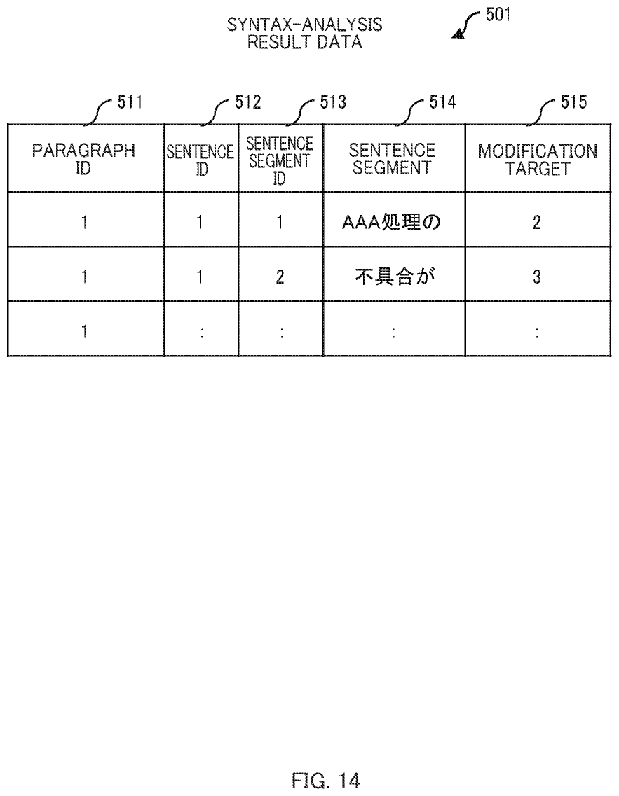

FIG. 14 is a diagram illustrating an example of syntax-analysis result data 501. The syntax-analysis result data 501 is a database in which the relationships between the sentence segments in each sentence of the set of sentences 5 are recorded and which includes one or more records having the following items: “paragraph ID” 511 that stores paragraph IDs, “sentence ID” 512 that stores the sentence ID of each sentence in the paragraph according to the paragraph ID 511, “sentence segment ID” 513 that stores the identifier (sentence segment ID) of the sentence segment in the sentence according to the sentence ID 512, “sentence segment” 514 that stores the content of the sentence segment according to the sentence segment ID 513, and “modification target” 515 that stores the sentence segment ID of the modification target modified by the sentence segment according to the sentence segment 514.

### (Sentence-Element Division-Result Data)

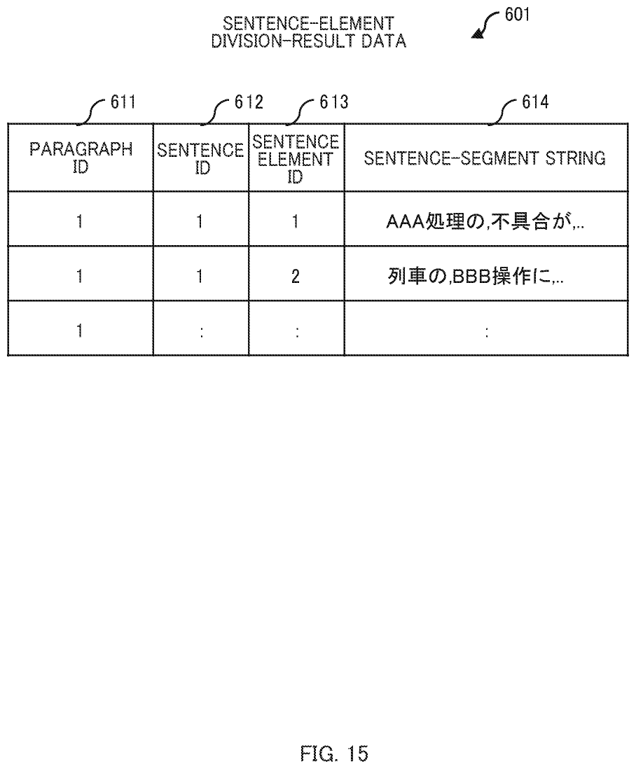

FIG. 15 is a diagram illustrating an example of sentence-element division-result data 601. The sentence-element division-result data 601 is a database in which the sentence elements of each sentence of the set of sentences 5 are recorded and which includes one or more records having the following items: “paragraph ID” 611 that stores paragraph IDs, “sentence ID” 612 that stores the sentence ID of each sentence in the paragraph according to the paragraph ID 611, “sentence element ID” 613 that stores the sentence element ID of a sentence element in the sentence according to the sentence ID 612, and “sentence-segment string” 614 that stores the content of the sentence element according to the sentence element ID 613.

### <Label Input Process>

Next, the following describes the label input process.

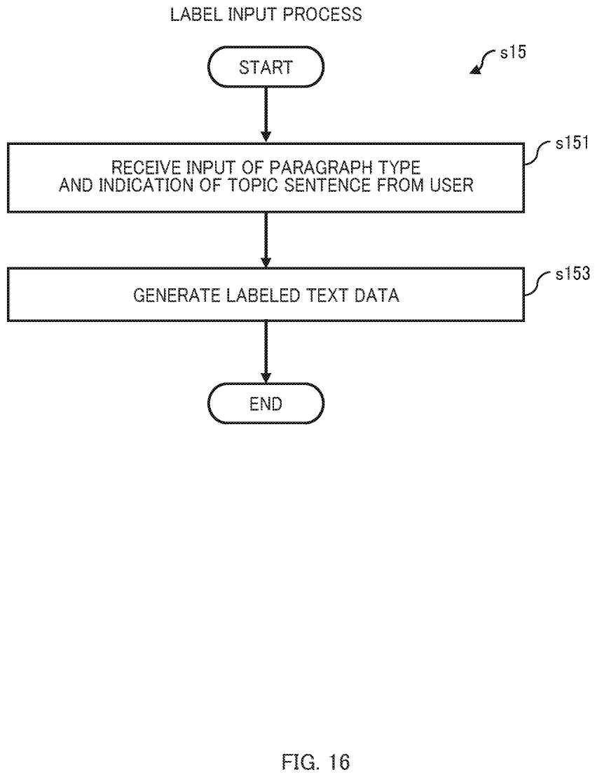

FIG. 16 is a flowchart for explaining an example of the label input process. First, the label input part 113 receives, from the user, an input of the paragraph type for each paragraph of the teacher text data 101 determined in the first paragraph division process (s151). The label input part 113 also receives, from the user, an input of information on the topic sentence-segment for each paragraph of the teacher text data 101 determined in the first paragraph division process (s151).

Then, the label input part 113 generates the labeled text data 104 based on the inputted data (s153).

### <Paragraph-Type-Discrimination-Model Creation Process>

Next, the following describes the paragraph-type-discrimination-model creation process.

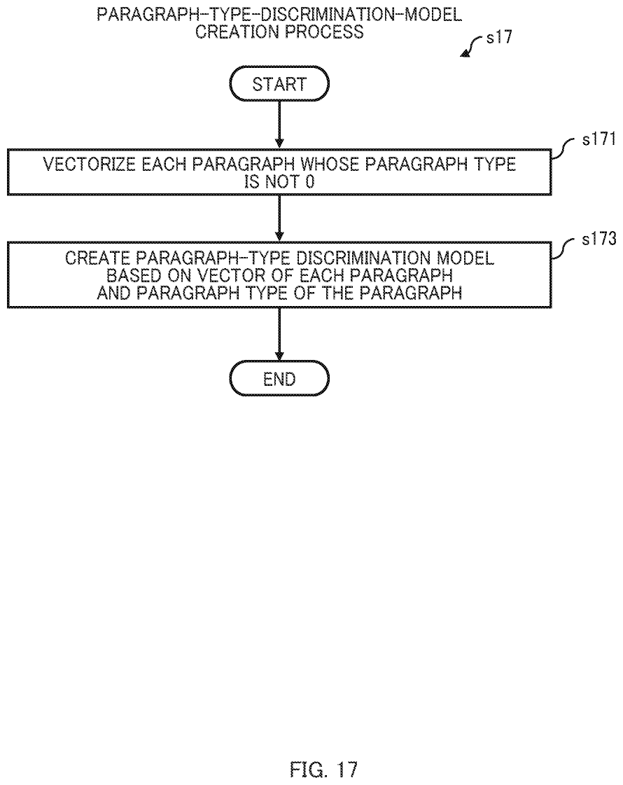

FIG. 17 is a flowchart for explaining an example of the paragraph-type-discrimination-model creation process. The paragraph-type-discrimination-model creation part 114 vectorizes each paragraph in the set of sentences 5 of the teacher text data 101 based on the paragraph type data 901 of the labeled text data 104 (s171).

Specifically, for example, the paragraph-type-discrimination-model creation part 114 obtains the contents of the sentences of all the paragraphs of which the paragraph types 912 of the paragraph type data 901 are not “0” from the text data with paragraph information 301 and generates word vectors on the obtained sentences of each paragraph, each vector having elements of the constituent words of each sentence. Note that this process can be achieved, for example, by doc2vec.

Then, the paragraph-type-discrimination-model creation part 114 learns the relationship among the word vectors of each paragraph generated at s171 and the paragraph type (paragraph type data 901) of each paragraph and thereby creates the paragraph-type discrimination model 105 (s173).

Next, the following describes the topic-discrimination-model creation process.

### <Topic-Discrimination-Model Creation Process>

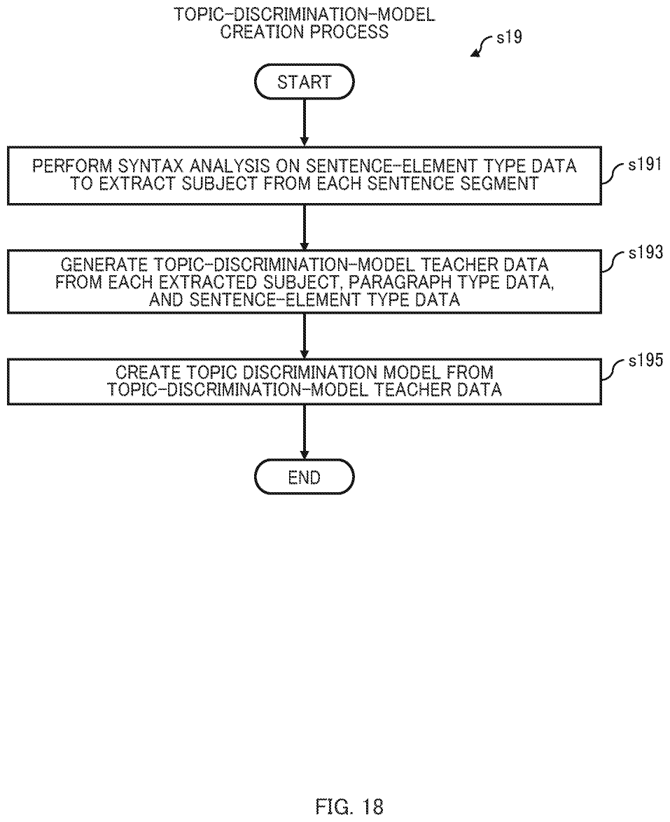

FIG. 18 is a flowchart for explaining an example of the topic-discrimination-model creation process. The topic-discrimination-model creation part 115 extracts subjects from the sentence segments in each sentence of the set of sentences 5 of the teacher text data 101 (s191). Specifically, for example, the topic-discrimination-model creation part 115 analyzes the content of the sentence-segment string 916 of each record in the sentence-element type data 902 of the labeled text data 104 and thereby determines the subject.

Then, the topic-discrimination-model creation part 115 combines information on the subject extracted at s191, the paragraph type data 901, and the sentence-element type data 902 and thereby generates topic-discrimination-model teacher data 1201 described below (s193) which is teacher data used as a base for creating the topic discrimination model 106 according to the teacher text data 101.

Then, the topic-discrimination-model creation part 115 learns the content of each record of the topic-discrimination-model teacher data 1201 generated at s193 to create the topic discrimination model (s195).

### (Topic-Discrimination-Model Teacher Data)

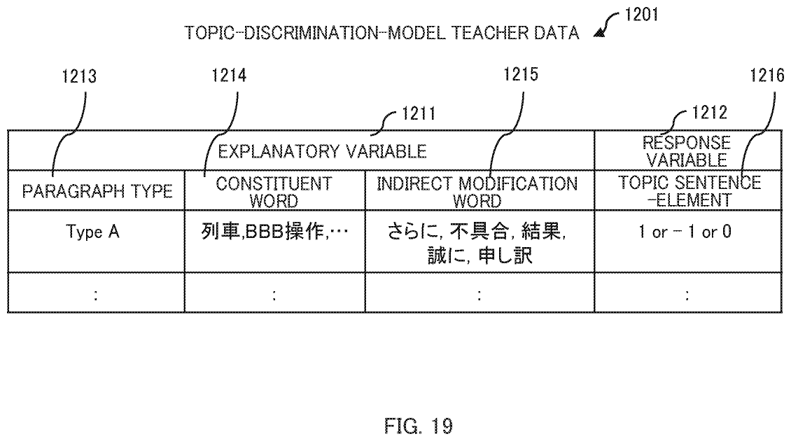

FIG. 19 is a diagram illustrating an example of topic-discrimination-model teacher data 1201. The topic-discrimination-model teacher data 1201 includes one or more records having the items of “explanatory variable” 1211 in which information on the explanatory variables of the topic discrimination model 106 is set and “response variable” 1212 in which information on the response variables of the topic discrimination model 106 is set.

The explanatory variable 1211 has the following subitems: “paragraph type” 1213 that stores paragraph types, “constituent word” 1214 that stores a list of the constituent words (excluding the subject) of a sentence element in the paragraph according to the paragraph type 1213, and “indirect modification word” 1215 that stores a list of the words (in other sentence elements) that have modification relationships with the sentence element.

The response variable 1212 has the item of “topic-sentence element” 1216. In the topic-sentence element 1216, if the sentence element has a topic sentence-segment, “1” is set by the user. If the sentence element does not have a topic sentence-segment, “−1” is set by the user. If whether the sentence element has a topic sentence-segment is unknown or whether the sentence element has a topic sentence-segment is going to be presumed by the topic discrimination model 106, “0” is set by the user.

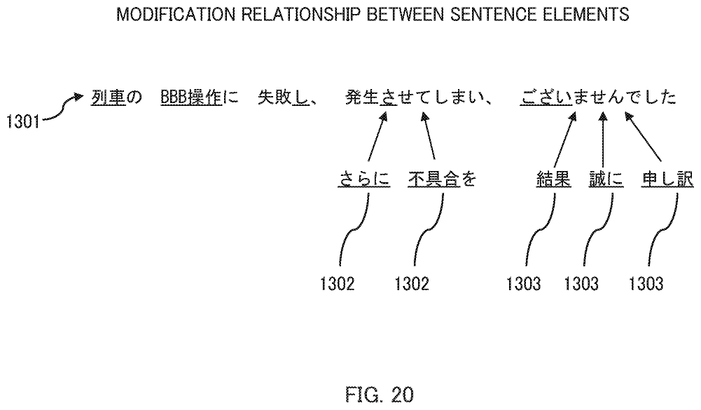

Note that FIG. 20 is a diagram for explaining an example of modification relationships between sentence elements. As illustrated in FIG. 20, a sentence element 1301 has modification relationships with two sentence elements 1302. The sentence element 1301 also has modification relationships with three sentence elements 1303. The set of sentences 5 has a structure in which the topic sentence-segment can be determined by the pattern of modification relationships as above.

### <Relationship-Information Generation Process>

Next, the following describes the relationship-information generation process.

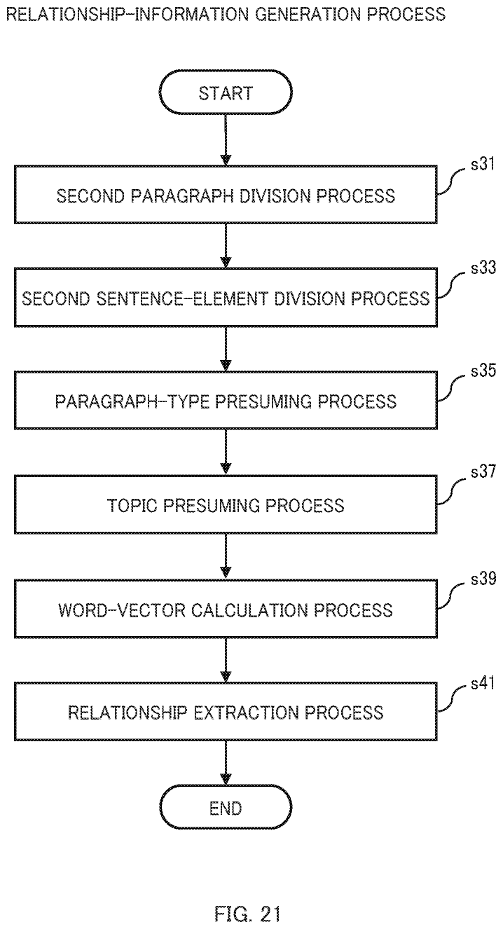

FIG. 21 is a flowchart for explaining an example of the relationship-information generation process. First, the paragraph division part 111 of the data extraction device 20 executes a process similar to the first paragraph division process (a second paragraph division process s31). Specifically, the paragraph division part 111 receives the text data for learning 102 from the document server 10 and divides the set of sentences 5 in the received text data for learning 102 into paragraphs.

Then, the sentence-element division part 112 executes a process similar to the first sentence-element division process (a second sentence-element division process s33). Specifically, the sentence-element division part 112 restructures each paragraph in the set of sentences 5 in the text data for learning 102 into sentence elements based on the results of the second paragraph division process.

Note that the results of the second paragraph division process and the second sentence-element division process are recorded in the labeled text data 104 (the paragraph type data 901 and the sentence-element type data 902), as in the discrimination-model creation process.

Next, the paragraph-type presuming part 116 inputs information on each paragraph resulting from the division at s31 (paragraph type data 901) into the paragraph-type discrimination model 105 created in the discrimination-model creation process and thereby presumes the paragraph type of each paragraph in the text data for learning 102 (a paragraph-type presuming process s35).

The topic presuming part 117 inputs information on each paragraph (the paragraph type data 901) resulting from the division at s31 and also information on the sentence elements of each paragraph (the sentence-element type data 902) into the topic discrimination model 106 created in the discrimination-model creation process and thereby presumes the topic sentence-segment of the text data for learning 102 (a topic presuming process s37).

Then, for each word in the text data for learning 102, the word-vector calculation part 118 calculates, based on the word, the paragraph type presumed at s35, and the topic sentence-segment presumed at s37, word vectors the feature amounts of which are these (a word-vector calculation process s39).

Then, the relationship extraction part 119 analyzes each word vector calculated at s39 to output relationship information (a relationship extraction process s41).

The following describes details of each process in the relationship-information generation process. Note that as described above, the processes in the second paragraph division process and the second sentence-element division process are the same as or similar to those in the first paragraph division process and the first sentence-element division process, respectively, and hence, description thereof is omitted.

### <Paragraph-Type Presuming Process>

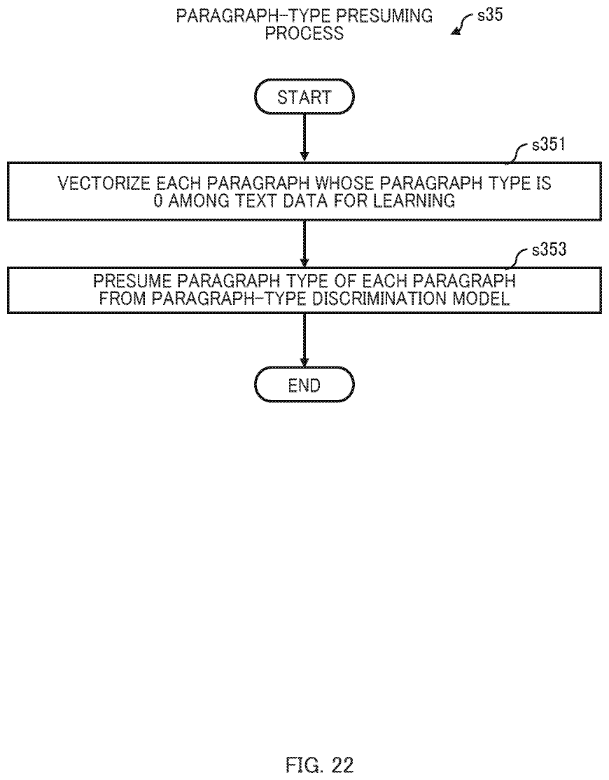

FIG. 22 is a flowchart for explaining an example of the paragraph-type presuming process. The paragraph-type presuming part 116 of the data extraction device 20 vectorizes each paragraph in the set of sentences 5 in the text data for learning 102 (s351).

Specifically, for example, the paragraph-type presuming part 116 obtains the contents of the sentences in each paragraph of which the paragraph type 912 of the paragraph type data 901 is “0” from the text data with paragraph information 301 and generates word vectors on the obtained sentences in each paragraph (the word vector having elements of the constituent words of the paragraph). Note that this process can be achieved, for example, by doc2vec.

Then, the paragraph-type presuming part 116 inputs the word vectors of each paragraph generated at s351 into the paragraph-type discrimination model 105 to presume the paragraph type of each paragraph (s353).

### <Topic Presuming Process>

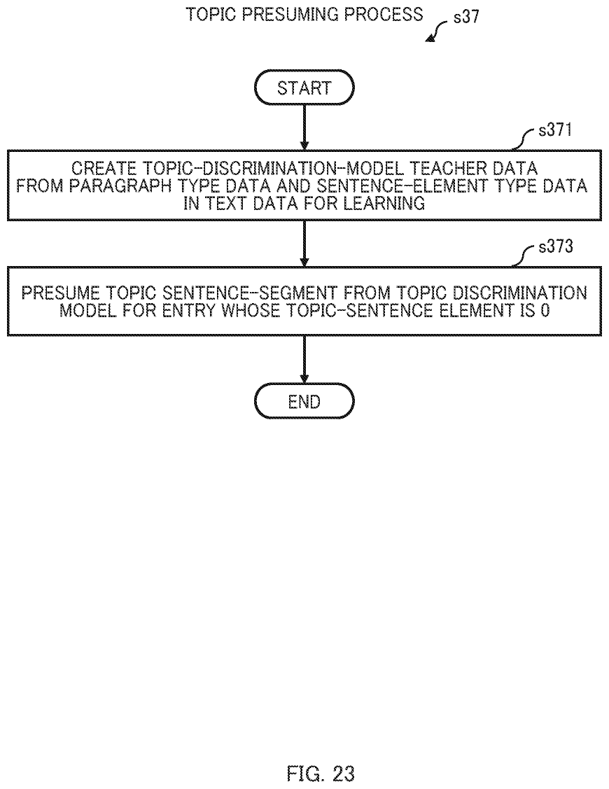

Next, FIG. 23 is a flowchart for explaining an example of the topic presuming process. The topic presuming part 117 of the data extraction device 20 combines information pieces on the records according to each set of sentences 5 in the text data for learning 102 among the information pieces in the paragraph type data 901 and the sentence-element type data 902, and thereby generates records of the topic-discrimination-model teacher data 1201 according to the text data for learning 102 (s371). Note that “0” is set in the topic-sentence element 1216 of the topic-discrimination-model teacher data 1201.

The topic presuming part 117 inputs the contents of the records of the topic-discrimination-model teacher data 1201 generated at s371 into the topic discrimination model 106 and thereby presumes a topic sentence-segment of each paragraph in each set of sentences 5 in the text data for learning 102 (s373). Specifically, for example, the topic presuming part 117 inputs the contents of the records the topic-sentence elements 1216 of which are “0” among the topic-discrimination-model teacher data 1201 into the topic discrimination model 106 to presume the topic sentence-segment.

### <Word-Vector Calculation Process>

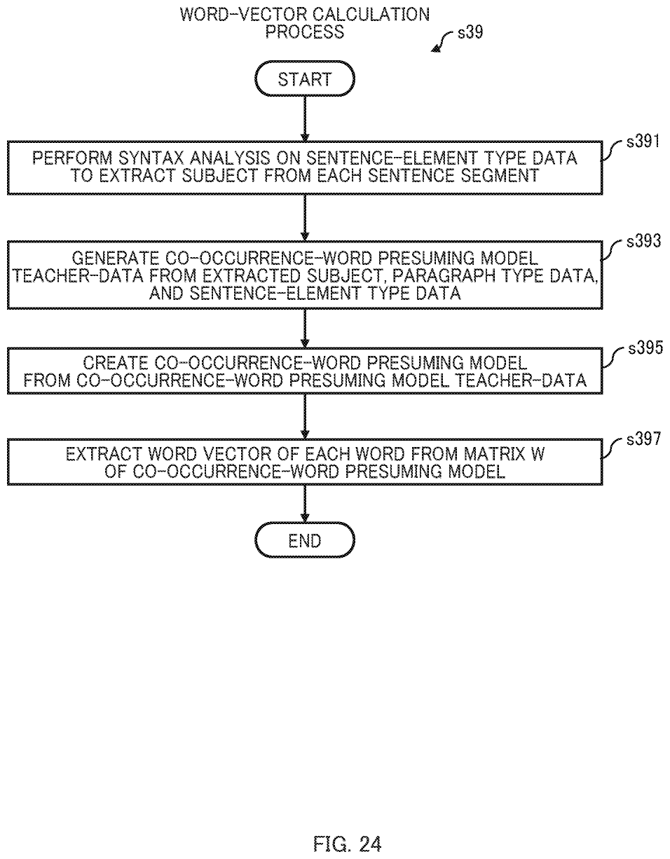

Next, FIG. 24 is a flowchart for explaining an example of the word-vector calculation process.

The word-vector calculation part 118 of the data extraction device 20 extracts subjects from the sentence segments in each sentence of the set of sentences 5 in the text data for learning 102 (s391). Specifically, for example, the word-vector calculation part 118 determines subjects by analyzing the contents of the sentence-segment strings 916 in the records of the text data for learning 102, among the sentence-element type data 902 of the labeled text data 104.

The word-vector calculation part 118 combines information on the subjects extracted at s391, the paragraph type data 901, and the sentence-element type data 902 and thereby generates co-occurrence-word presuming model teacher-data 1601 described later which is teacher data used as a base for creating the co-occurrence-word presuming model 108 (s393).

The word-vector calculation part 118 learns the content of each record in the co-occurrence-word presuming model teacher-data 1601 generated at s393 to create the co-occurrence-word presuming model 108 described next (s395).

Then, the word-vector calculation part 118 extracts the word vector of each word from the co-occurrence-word presuming model 108 created at s395 (s397).

Here, the following describes the co-occurrence-word presuming model teacher-data 1601 and the co-occurrence-word presuming model 108.

### (Co-Occurrence-Word Presuming Model Teacher-Data)

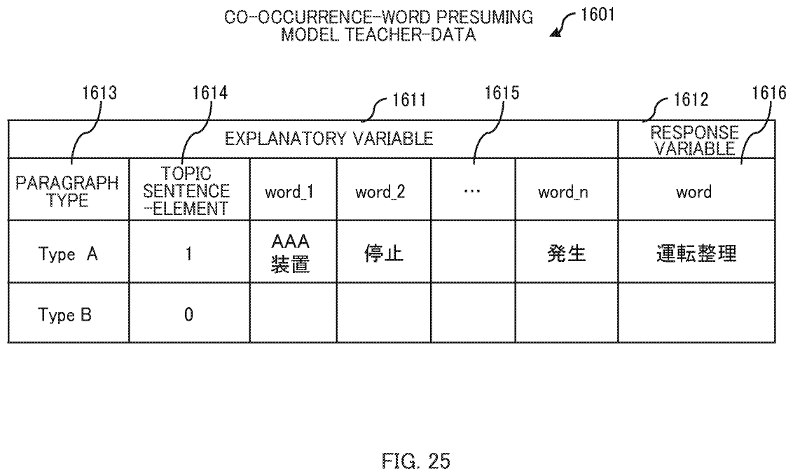

FIG. 25 is a diagram illustrating an example of the co-occurrence-word presuming model teacher-data 1601. The co-occurrence-word presuming model teacher-data 1601 includes one or more records having the items of “explanatory variable” 1611 in which information on the explanatory variables of the co-occurrence-word presuming model 108 is set and “response variable” 1612 in which information on the response variables of the co-occurrence-word presuming model 108 is set.

The explanatory variable 1611 has subitems including “paragraph type” 1613 that stores paragraph types, “topic-sentence element” 1614 that stores information on whether the paragraph according to the paragraph type 1613 has a topic sentence-segment, “word” 1615 that stores a list of the words that, in the case where the paragraph according to the paragraph type 1613 has a topic sentence-segment, occur in the topic sentence-segment (excluding the words according to the response variable 1612 described later).

In the topic-sentence element 1614, if the paragraph according to the paragraph type 1613 has a topic sentence-segment, “1” is set, and if it does not have a topic sentence-segment, “0” is set.

The response variable 1612 has the item of “word” 1616. The word 1616 stores one word other than the words according to the words 1615 among the constituent words of the paragraph according to the paragraph type 1613.

### (Co-Occurrence-Word Presuming Model)

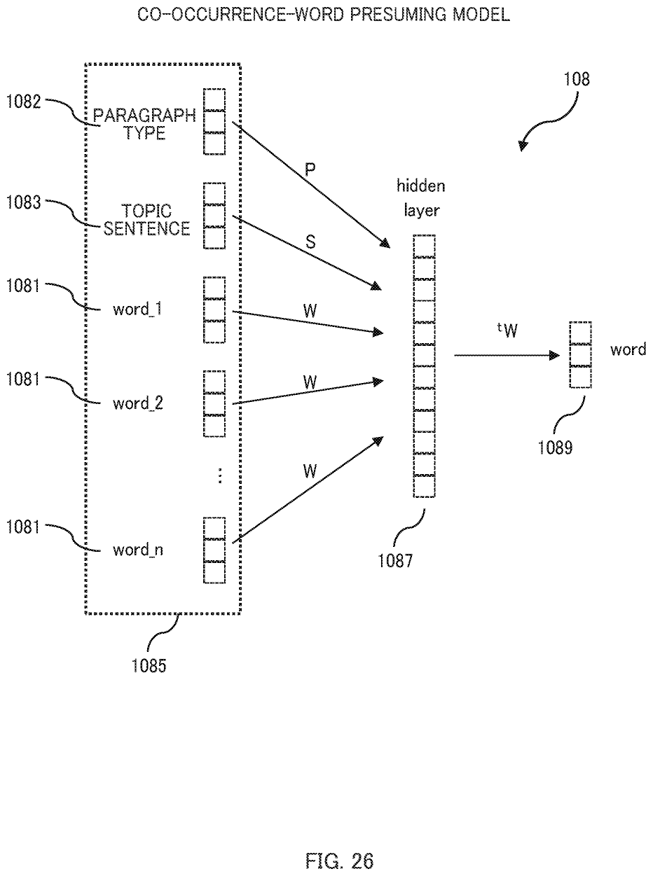

FIG. 26 is a diagram for explaining an example of the structure of a co-occurrence-word presuming model 108. As illustrated in FIG. 26, the co-occurrence-word presuming model 108 is a neural network including an input layer 1085, a specified hidden layer 1087, and an output layer 1089. The input layer 1085 has, in addition to the words 1081 which are the elements of general word vectors, the paragraph types 1082 as vector elements and information 1083 on whether the paragraphs have topic sentence-segments as vector elements. The output layer 1089 is co-occurrence words corresponding to the input layer 1085 and the hidden layer 1087.

### <Relationship Extraction Process>

Next, the following describes the relationship extraction process.

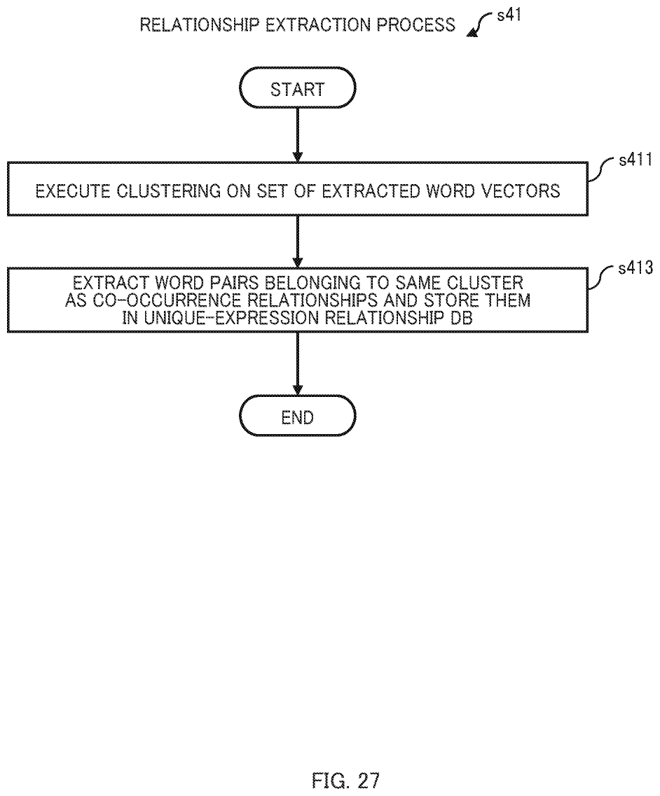

FIG. 27 is a flowchart for explaining an example of the relationship extraction process. The relationship extraction part 119 of the data extraction device 20 executes a specified clustering process on each word extracted in the word-vector calculation process (s411). Note that for this clustering process, existing techniques (non-hierarchical cluster analyses) such as the k-means method can be used, for example.

Then, on the basis of the results of the clustering process at s411, the relationship extraction part 119 determines a combination of words determined to belong to the same cluster (here, assume two words) as a set of words having co-occurrence relationships and stores the determined results in the unique-expression relationship DB 107 (s413).

### (Unique-Expression Relationship DB)

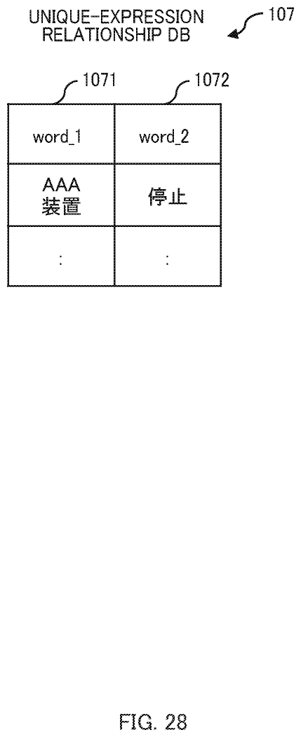

Here, FIG. 28 is a diagram illustrating an example of a unique-expression relationship DB 107. The unique-expression relationship DB 107 is a database in which a list of unique expressions having co-occurrence relationships are recorded and which includes one or more records having the items of “first unique expression” 1071 that stores unique expressions (words or the like) and “second unique expression” 1072 that stores unique expressions (words or the like) having a co-occurrence relationship with the unique expression according to the first unique expression 1071. Note that the data extraction device may display the contents of this unique-expression relationship DB 107 thus generated on a specified result screen.

Note that after that, the data extraction device 20 can perform a specified work analysis by inputting the created unique-expression relationship DB 107 into the analysis device 30. For example, the analysis device 30 receives an input of information on a problem case on work from a user unskilled in the work and can output analysis results 109 which are information on coping methods of the failure, based on the information the input of which has been received and the unique-expression relationship DB 107 (or a specified pre-trained model created based on the unique-expression relationship DB 107).

### Second Embodiment

Next, the following describes a work analysis system 1 according to a second embodiment. In the work analysis system 1 according to the present embodiment, it is assumed that the set of sentences 5 are English sentences. In this case, details of the sentence-element division process and the topic-discrimination-model creation process in the work analysis system 1 are significantly different from those in the first embodiment. Hence, these processes are described in detail below.

### <Sentence-Element Division Process>

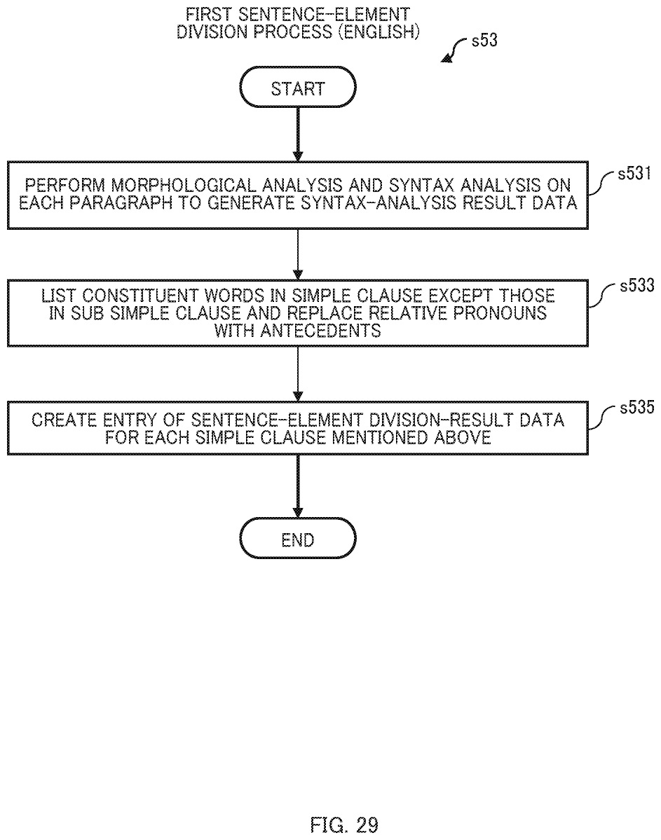

FIG. 29 is a flowchart for explaining an example of the first sentence-element division process according to the second embodiment. First, the first sentence-element division part 112, as in the first embodiment, determines each sentence segment in the teacher text data 101 and records the results in syntax-analysis result data 2101 described later (s531).

Then, the first sentence-element division part 112 performs a syntax analysis on each sentence segment determined at s531 to determine the sentence elements (the constituent words in simple clauses except those in sub simple clauses) and replaces relative pronouns with their antecedents (s533).

The first sentence-element division part 112 determines the content of each simple clause (sentence element) determined at s533 and records the determined content in sentence-element division-result data 2201 (s535) described later.

Here, the syntax-analysis result data 2101 and the sentence-element division-result data 2201 are described below.

### (Syntax-Analysis Result Data)

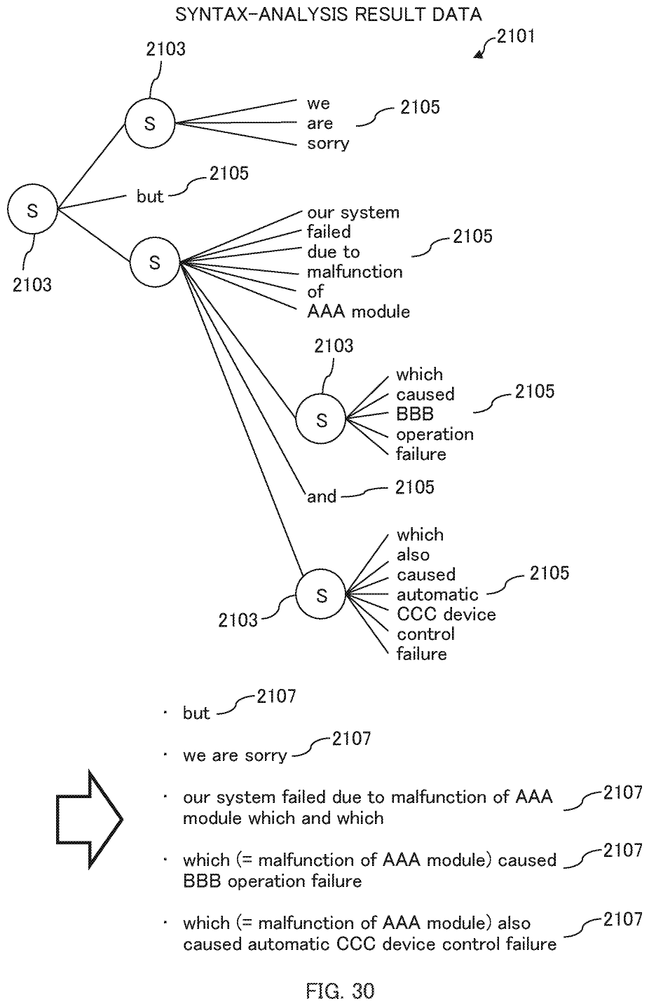

FIG. 30 is a diagram for explaining an example of syntax-analysis result data 2101. This syntax-analysis result data 2101 shows the structure of a complex sentence in the teacher text data 101 using a syntax tree and includes a plurality of nodes 2103. Each of the nodes 2103 has elements of one or a plurality of constituent words 2105. Based on such a syntax tree, the teacher text data 101 is restructured into a plurality of sentence elements 2107.

### (Sentence-Element Division-Result Data)

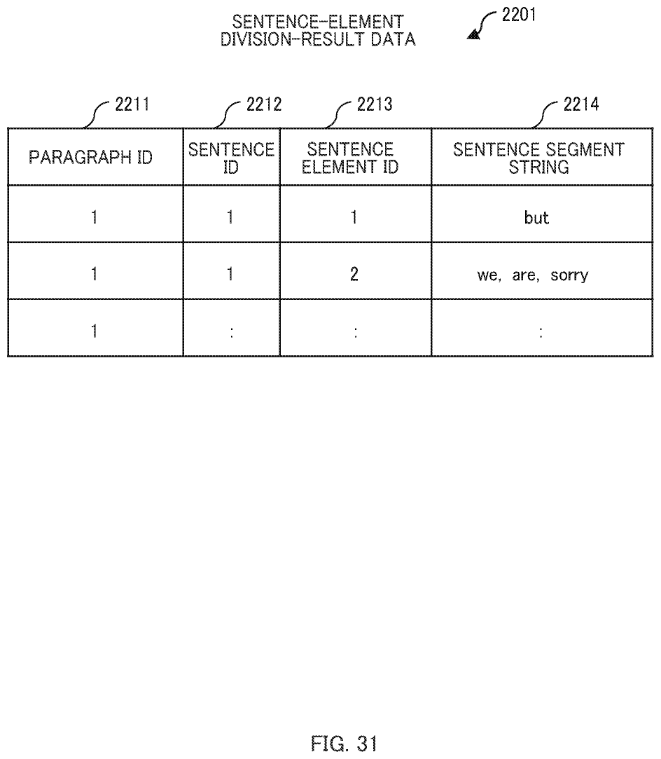

FIG. 31 is a diagram illustrating an example of sentence-element division-result data in the second embodiment. The sentence-element division-result data 2201 includes one or more records having the following items: “paragraph ID” 2211 that stores paragraph IDs, “sentence ID” 2212 that stores the sentence ID of each sentence in the paragraph according to the paragraph ID 2211, “sentence element ID” 2213 that stores the sentence element ID of each sentence element in the sentence according to the sentence ID 2212, and “sentence-segment string” 2214 that stores the words (the sentence-segment string) included in the sentence element according to the sentence element ID 2213.

As above, the sentence-element division process in the second embodiment additionally includes a correction process for the difference in syntax between Japanese and English such as a complex sentence including relative pronouns.

The other processes are the same as or similar to those in the first embodiment.

### <Topic-Discrimination-Model Creation Process>

Next, the following describes a topic-discrimination-model creation process according to the second embodiment.

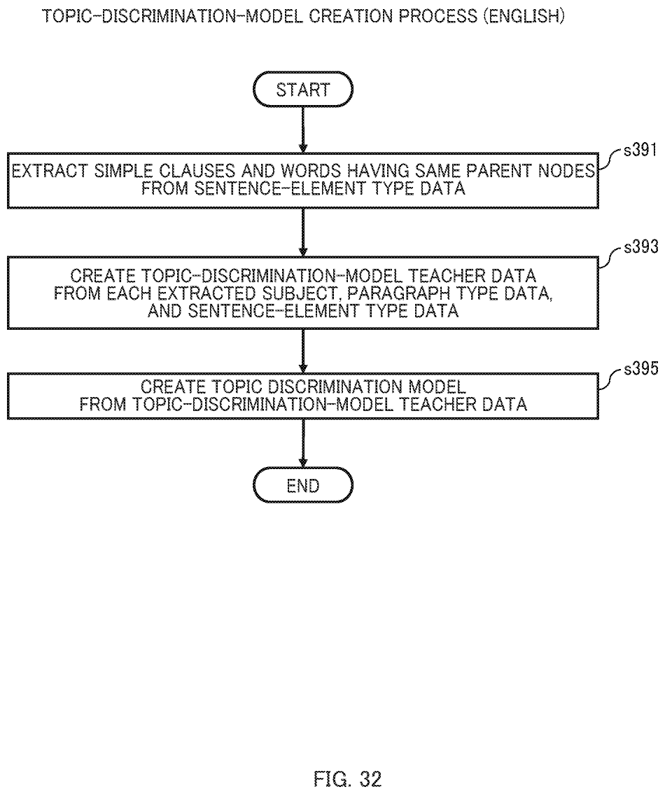

FIG. 32 is a flowchart for explaining an example of the topic-discrimination-model creation process according to the second embodiment. First, the topic-discrimination-model creation part 115 extracts the subject from the sentence segments of each sentence in the set of sentences 5 of the teacher text data 101 (s391). Specifically, for example, the topic-discrimination-model creation part 115 analyzes the syntax-analysis result data 2101 and the content of the sentence-segment string 916 of each record of the sentence-element type data 902 in the labeled text data 104 and thereby extracts simple clauses having the same parent node 2103 and the constituent words in the simple clauses.

Then, the topic-discrimination-model creation part 115 generates topic-discrimination-model teacher data 1201 based on information on the subjects extracted at s391 as in the first embodiment (s393).

The topic-discrimination-model creation part 115, as in the first embodiment, learns the content of each record of the topic-discrimination-model teacher data 1201 generated at s393 to create the topic discrimination model 106 (s395).

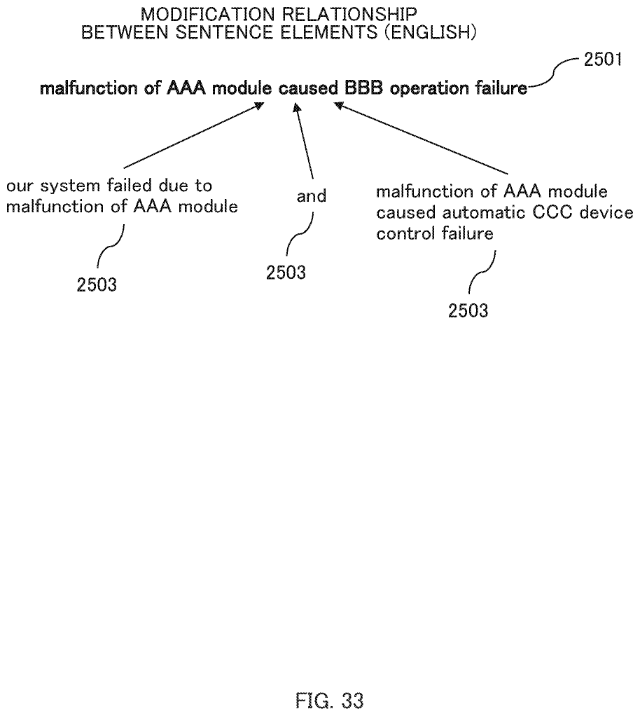

FIG. 33 is a diagram for explaining an example of modification relationships between sentence elements in the second embodiment. As illustrated in FIG. 33, the sentence element 2501 has modification relationships with a plurality of other sentence elements 2503 (“our system failed due to malfunction of AAA module”, “and”, and “malfunction of AAA module caused automatic CCC device control failure”).

Here, the following describes the topic-discrimination-model teacher data 2401.

### (Topic-Discrimination-Model Teacher Data)

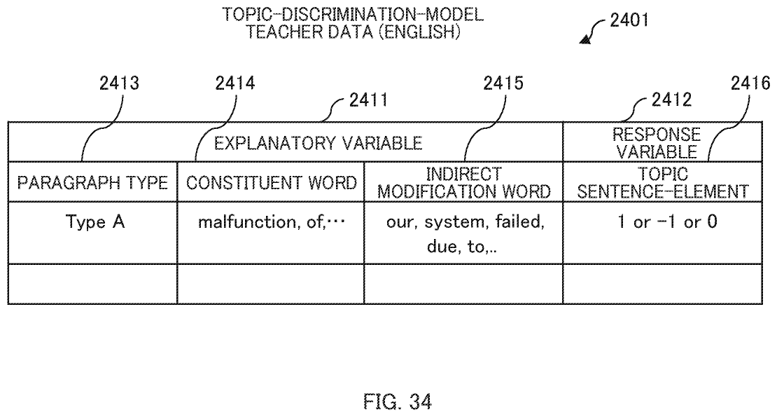

FIG. 34 is a diagram illustrating an example of topic-discrimination-model teacher data 2401 according to the second embodiment. The topic-discrimination-model teacher data 2401, as in the first embodiment, includes one or more records having the items of “explanatory variable” 2411 and “response variable” 2412. Also, the explanatory variable 2411, as in the first embodiment, has the subitems of “paragraph type” 2413, “constituent word” 2414, and “indirect modification word” 2415. Also, the response variable 2412 has the item of “topic-sentence element” 2416 as in the first embodiment.

As above, in the topic-discrimination-model creation process of the second embodiment, the method of extracting subjects is different from the one in the first embodiment.

As has been described above, the data extraction device 20 of the present embodiment receives, from the user, an input of the type (for example, the paragraph type) of each component of each set of sentences 5 according to the teacher text data 101 and a designation of the topic portion (for example, the topic sentence-segment) in the component. The data extraction device 20 also creates a pre-trained model 140 according to the words in the set of sentences 5, the types of the components, and the topic portions. Then, the data extraction device 20 inputs the set of sentences 5 (the text data for learning) inputted by the user to the pre-trained model 140, thereby presumes the types of the components in the set of sentences 5 and the topic portions, calculates the feature amount of each word in the set of sentences 5, and extracts a plurality of words having a relationship with one another based on the calculated feature amounts.

Specifically, in sets of sentences 5 on a work field, the types of components and how topic portions occur have, in general, limited patterns. Hence, since these input and designation are received from the user on the set of sentences 5 which serves as teacher data, pre-trained models 140 with which the contents of the set of sentences 5 can be presumed with high accuracy can be at least created reliably even if the amount of the teacher data is small. The use of pre-trained models 140 as above makes it possible to appropriately and efficiently presume the features of the words in a new set of sentences 5 (text data for learning 102) specified by the user. As a result, it is possible to extract and output the words in the set of sentences 5 having a relationship with each other (for example, unique expressions having co-occurrence relationships). Thus, the data extraction device 20 of the present embodiment is capable of extracting characteristic data from text data appropriately and efficiently according to the work field.

The description of the above embodiments is for making it easy to understand the present disclosure, and it is not for limiting the present disclosure. The present disclosure can be changed or improved without departing from the spirit, and the present disclosure also includes equivalents thereof.

For example, although it is assumed in the present embodiments that the work field of the set of sentences 5 is a railway business, the present disclosure is applicable to other businesses involving specific work as long as the set of sentences 5 has features on the component unit (paragraph type) and the topic portion (topic sentence-segment).

In addition, although it is assumed in the present embodiments that the components of the set of sentences 5 are paragraphs, other units may be employed. For example, the components may be pages, sections, chapters, clauses, or the like. Depending on what the components are, the contents in the paragraph division rules 103 are changed.

In addition, although the types of the component units (paragraphs) of the set of sentences 5 in the present embodiments are titles 50(1), introductions 50(2), and the like, other types of paragraphs may be used as long as paragraphs may be classified into specific types.

In addition, although it is assumed in the present embodiments that topic portions are sentence segments, topic portions may be sentences or other portions.

In addition, although the description in the present embodiments are based on the cases where the language of text data is Japanese or English, the language may be other ones.

In addition, although the unique-expression relationship DB 107 in the present embodiments is a database in which co-occurrence relationships between two words are recorded, it may be one in which relationships among three or more words are recorded.

In addition, although in the present embodiments, the two models of the paragraph-type discrimination model 105 and the topic discrimination model 106 are built as pre-trained models that have learned the features of the set of sentences 5, the pattern of pre-trained models that are created is not limited to this example. For example, one pre-trained model that simultaneously outputs paragraph types and the features of topic sentence-segments may be built, or three or more pre-trained models may be combined.

According to the above description of the present specification, at least the following is clear. Specifically, in the data extraction device of the present embodiments, the model creation part may include a paragraph-type-discrimination-model creation part and a topic-discrimination-model creation part, the paragraph-type-discrimination-model creation part may learn a relationship between each word in the set of sentences and the type of the component to create a paragraph-type discrimination model that has memorized the relationship between the word and the type of the component, as a first pre-trained model, the topic-discrimination-model creation part may create a topic discrimination model that has memorized a relationship among the type of the component, the words in the component, and the topic portion in the component, as a second pre-trained model, the sentence-feature presuming part may include a paragraph-type presuming part and a topic presuming part, the paragraph-type presuming part may input a specified set of sentences inputted by a user into the first pre-trained model to presume the type of each component of the specified set of sentences, and the topic presuming part may input the specified set of sentences into the second pre-trained model to presume a topic portion in each component of the specified set of sentences.

As above, since the paragraph-type discrimination model 105 that has memorized the relationship among the words and the types (paragraph types) of the components and the topic discrimination model 106 that has memorized the relationship among the type (paragraph type) of a component, the words in the component (paragraph), and the topic portion (topic sentence-segment) in the component (paragraph) are used as the pre-trained models 140, it is possible to extract the features of the teacher text data 101 accurately according to the work field.

In addition, in the data extraction device of the present embodiments, the topic-discrimination-model creation part may create, as the topic discrimination model, a model having at least each word in the component and a word having a modification relationship with the word as a feature amount, and the topic presuming part may input each word in the component of the specified set of sentences and a word having a modification relationship with the word into the topic discrimination model to presume the topic portion.

As above, since the topic portion is presumed with the topic discrimination model 106 that has at least each word in the component (paragraph) and a word having a modification relationship with the word as a feature amount, it is possible to determine the topic portion of the paragraph accurately according to the context.

In addition, in the data extraction device of the present embodiments, the word-vector generation part may learn the relationship among each word in the specified set of sentences, the type of each presumed component, and the presumed topic portion to create a co-occurrence-word presuming model that has memorized the relationship among the occurrence of the words in the specified set of sentences, the type of a component in the specified set of sentences, and a topic portion in the component, and the word-vector generation part may calculate a feature amount of each word based on the created co-occurrence-word presuming model.

As above, since the feature amount of each word is calculated based on the co-occurrence-word presuming model 108 that has memorized the relationship among the occurrence of the words in the specified set of sentences 5 (the teacher text data 101 in the document server 10), the types (paragraph types) of the components in the specified set of sentences 5, and the topic portion (topic sentence-segment) of the components, it is possible to calculate the feature amount that corresponds to the paragraph type and the topic sentence-segment which are the features of the set of sentences 5 and reflects the characteristic of each word sufficiently in the work field.

In addition, the data extraction device of the present embodiments may further comprise an output part that outputs a plurality of the extracted words having a relationship with one another.

As above, since information on a plurality of words having a relationship with one another is outputted, the user can use the content of the output to perform work analysis or the like efficiently. For example, the user can perform data search based on the outputted information or can create a new pre-trained model for performing work analysis.

What is claimed is:

1. A data extraction device comprising:
a label input part that receives, from a user, an input of the type of each component of at least one set of sentences and a designation of a topic portion in the component;
a model creation part that creates a pre-trained model that has learned the type of each component of the set of sentences and a feature of the topic portion in the component of the set of sentences;
a sentence-feature presuming part that inputs a specified set of sentences inputted by a user into the pre-trained model to presume each component of the specified set of sentences and a topic portion in each component of the specified set of sentences;
a word-vector generation part that determines a relationship among each word in the specified set of sentences, the type of each presumed component, and the presumed topic portion to calculate a feature amount of each word; and
a relationship extraction part that extracts a plurality of the words having a relationship with one another based on the calculated feature amount.

2. The data extraction device according to claim 1, wherein
the model creation part includes a paragraph-type-discrimination-model creation part and a topic-discrimination-model creation part,
the paragraph-type-discrimination-model creation part learns a relationship between each word in the set of sentences and the type of the component to create a paragraph-type discrimination model that has memorized the relationship between the word and the type of the component, as a first pre-trained model,
the topic-discrimination-model creation part creates a topic discrimination model that has memorized a relationship among the type of the component, the words in the component, and the topic portion in the component, as a second pre-trained model,
the sentence-feature presuming part includes a paragraph-type presuming part and a topic presuming part,
the paragraph-type presuming part inputs a specified set of sentences inputted by a user into the first pre-trained model to presume the type of each component of the specified set of sentences, and
the topic presuming part inputs the specified set of sentences into the second pre-trained model to presume a topic portion in each component of the specified set of sentences.

3. The data extraction device according to claim 1, wherein
the topic-discrimination-model creation part creates, as the topic discrimination model, a model having at least each word in the component and a word having a modification relationship with the word as a feature amount, and
the topic presuming part inputs each word in the component of the specified set of sentences and a word having a modification relationship with the word into the topic discrimination model to presume the topic portion.

4. The data extraction device according to claim 1, wherein
the word-vector generation part learns the relationship among each word in the specified set of sentences, the type of each presumed component, and the presumed topic portion to create a co-occurrence-word presuming model that has memorized the relationship among the occurrence of the words in the specified set of sentences, the type of a component in the specified set of sentences, and a topic portion in the component, and the word-vector generation part calculates a feature amount of each word based on the created co-occurrence-word presuming model.

5. The data extraction device according to claim 1, further comprising an output part that outputs a plurality of the extracted words having a relationship with one another.

6. A data extraction method comprising:
a label input process of receiving, from a user, an input of the type of each component of at least one set of sentences and a designation of a topic portion in the component;
a model creation process of creating a pre-trained model that has learned the type of each component of the set of sentences and a feature of the topic portion in the component of the set of sentences;
a sentence-feature presuming process of inputting a specified set of sentences inputted by a user into the pre-trained model to presume each component of the specified set of sentences and a topic portion in each component of the specified set of sentences;
a word-vector generation process of determining a relationship among each word in the specified set of sentences, the type of each presumed component, and the presumed topic portion to calculate a feature amount of each word; and
a relationship extraction process of extracting a plurality of the words having a relationship with one another based on the calculated feature amount, wherein
the label input process, the model creation process, the sentence-feature presuming process, the word-vector generation process, and the relationship extraction process are performed by an information processing device.

7. The data extraction method according to claim 6, wherein
the model creation process includes a paragraph-type-discrimination-model creation process and a topic-discrimination-model creation process,
the sentence-feature presuming process includes a paragraph-type presuming process and a topic presuming process,
in the paragraph-type-discrimination-model creation process, the information processing device learns a relationship between each word in the set of sentences and the type of the component to create a paragraph-type discrimination model that has memorized the relationship between the word and the type of the component, as a first pre-trained model,
in the topic-discrimination-model creation process, the information processing device creates a topic discrimination model that has memorized a relationship among the type of the component, the words in the component, and the topic portion in the component, as a second pre-trained model,
in the paragraph-type presuming process, the information processing device inputs a specified set of sentences inputted by a user into the first pre-trained model to presume the type of each component of the specified set of sentences, and
in the topic presuming process, the information processing device inputs the specified set of sentences into the second pre-trained model to presume a topic portion in each component of the specified set of sentences.

8. The data extraction method according to claim 7, wherein
in the topic-discrimination-model creation process, the information processing device creates, as the topic discrimination model, a model having at least each word in the component and a word having a modification relationship with the word as a feature amount, and
in the topic presuming process, the information processing device inputs each word in the component of the specified set of sentences and a word having a modification relationship with the word into the topic discrimination model to presume the topic portion.

9. The data extraction method according to claim 6, wherein
in the word-vector generation process, the information processing device learns the relationship among each word in the specified set of sentences, the type of each presumed component, and the presumed topic portion to create a co-occurrence-word presuming model that has memorized the relationship among the occurrence of the words in the specified set of sentences, the type of a component in the specified set of sentences, and a topic portion in the component, and the information processing device calculates a feature amount of each word based on the created co-occurrence-word presuming model.

10. The data extraction method according to claim 6, wherein
the information processing device executes an output process of outputting a plurality of the extracted words having a relationship with one another.
